(19) United States
(12) Patent Application Publication
(10) Pub. No.: US 2017/0286970 A1
(43) Pub. Date: Oct. 5, 2017

(54) ANSWER-SUGGESTION SYSTEM FOR AUTOMATICALLY RESOLVING CUSTOMER REQUESTS

(71) Applicant: Zendesk, Inc., San Francisco, CA (US)

(72) Inventor: Thomas Pelletier, Montpellier (FR)

(73) Assignee: Zendesk, Inc., San Francisco, CA (US)

(21) Appl. No.: 15/087,755

(22) Filed: Mar. 31, 2016

(51) Int. Cl. G06Q 30/00; G06F 17/30

(52) U.S. Cl. CPC G06Q 30/016; G06F 17/30867

(57) ABSTRACT

The disclosed embodiments relate to a system that suggests helpful articles to automatically resolve a customer request. During operation, the system receives the customer request, wherein the customer request is associated with a product or a service used by the customer. Next, the system determines whether the customer request matches one or more similar previously received customer requests. If so, the system identifies one or more helpful articles that were useful in resolving the one or more previously received customer requests, and then uses the one or more helpful articles to generate a set of suggested articles. Finally, the system presents the set of suggested articles to the customer to facilitate automatically resolving the customer request.

### BACKGROUND

### Field

The disclosed embodiments generally relate to computer-based applications that aid businesses in managing customer-service interactions. More specifically, the disclosed embodiments relate to an answer-suggestion system that automatically suggests knowledge-base articles for customers to read to facilitate resolving customer requests.

### Related Art

As electronic commerce continues to proliferate, customers are beginning to use online customer-service resources to solve problems, or to obtain information related to various products or services. These online customer-service resources commonly include ticketing systems, product-related knowledge bases, and online chat systems that are designed to help customers resolve their problems, either by providing information to the customers, or by facilitating online interactions with customer-support agents.

When designed properly, these online customer-service resources can automate customer-service interactions, thereby significantly reducing a company's service costs. Research has shown that customers can be satisfied with self-service solutions to their problems, for example by receiving articles containing information that can be used to resolve their problem, especially if the request can be resolved in minutes, as opposed to hours or days if the request is answered by a human customer-support agent.

Hence, what is needed is a customer-service system that automatically resolves customer-service requests by suggesting articles containing helpful information.

### SUMMARY

The disclosed embodiments relate to a system that suggests helpful articles to automatically resolve a customer request. During operation, the system receives the customer request, wherein the customer request is associated with a product or a service used by the customer. Next, the system determines whether the customer request matches one or more similar previously received customer requests. If so, the system identifies one or more helpful articles that were useful in resolving the one or more previously received customer requests, and then uses the one or more helpful articles to generate a set of suggested articles. Finally, the system presents the set of suggested articles to the customer to facilitate automatically resolving the customer request.

In some embodiments, using the one or more helpful articles to generate a set of suggested articles comprises: (1) using a search engine to select a preliminary set of suggested articles from a set of possible articles based on correlations between words in the customer request and words in the set of possible articles; and (2) modifying the preliminary set of suggested articles based on the one or more helpful articles to produce the set of suggested articles.

In some embodiments, modifying the preliminary set of suggested articles based on the one or more helpful articles includes re-ranking the preliminary set of suggested articles based on whether any of the preliminary set of articles also appears in the one or more helpful articles.

In some embodiments, modifying the preliminary set of suggested articles based on the one or more helpful articles includes inserting at least one of the one or more helpful articles into the preliminary set of suggested articles.

In some embodiments, the system additionally receives feedback from the customer regarding whether the one or more helpful articles were helpful in resolving the customer request. The system then uses the feedback to update a model used to identify helpful articles to resolve future customer requests.

In some embodiments, while determining whether the customer request matches one or more similar previously received customer requests, the system: (1) uses words from the customer request to generate a vector of numerical values representing the customer request; and (2) compares the vector representing the customer request against vectors representing previously received customer requests to determine whether the customer request matches one or more previously received customer requests.

In some embodiments, generating the vector includes using the Doc2Vec technique to generate the vector to represent the customer request.

In some embodiments, the customer request includes a question from the customer about the product or the service used by the customer.

In some embodiments, the customer request comprises a ticket associated with a customer issue in a help desk ticketing system.

In some embodiments, the article-suggestion process takes place asynchronously by the help desk system after the ticket is initially processed by the help desk ticketing system.

### BRIEF DESCRIPTION OF THE FIGURES

FIG. 1 illustrates a computing environment including an application and associated ticketing system in accordance with the disclosed embodiments.

FIG. 2 illustrates system components involved in the article-suggestion process in accordance with the disclosed embodiments.

FIG. 3 presents a system diagram illustrating the article-suggestion process in accordance with the disclosed embodiments.

FIG. 4A presents a flow chart illustrating the article-suggestion process in accordance with the disclosed embodiments.

FIG. 4B presents a flow chart illustrating how customer requests are compared in accordance with the disclosed embodiments.

FIG. 4C presents a flow chart illustrating how customer feedback is used to update a model used to identify helpful articles in accordance with the disclosed embodiments.

FIG. 5 illustrates how suggested articles can be presented to a customer in accordance with the disclosed embodiments.

FIG. 6 illustrates a user interface (UI) that enables a customer to provide feedback to the system in accordance with the disclosed embodiments.

### DETAILED DESCRIPTION

The following description is presented to enable any person skilled in the art to make and use the present embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a computer system.

The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Computing Environment

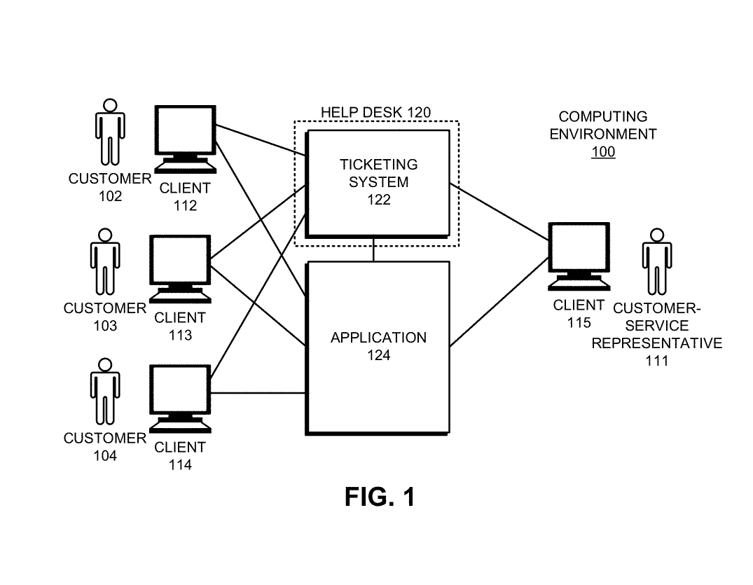

FIG. 1 illustrates a computing environment 100 including an application 124 and ticketing system 122 in accordance with the disclosed embodiments. Within computing environment 100, a number of customers 102-104 interact with application 124 through client computer systems 112-114, respectively. Application 124 is provided by an organization, such as a commercial enterprise, to enable customers 102-104 to perform various operations associated with the organization, or to access one or more services provided by the organization. For example, application 124 can include online accounting software that customers 102-104 can access to prepare and file tax returns online. In another example, application 124 provides a commercial website for selling sporting equipment. Note that application 124 can be hosted on a local or remote server.

If customers 102-104 have problems or questions about application 124, they can access a help desk 120 to obtain help in dealing with issues, which can include various problems and questions. For example, a user of accounting software may need help in using a feature of the accounting software, or a customer of a website that sells sporting equipment may need help in cancelling an order that was erroneously entered. This help may be provided by a customer-service representative 111 who operates a client computer system 115 and interacts with customers 102-104 through help desk 120. This help may also comprise automatically suggested helpful articles that the customer can read to hopefully resolve the problem or question. Note that customer-service representative 111 can access application 124 (either directly or indirectly through help desk 120) to help resolve an issue.

In some embodiments, help desk 120 is not associated with computer-based application 124, but is instead associated with another type of product or service that is offered to a customer. For example, help desk 120 can provide assistance with a product, such as a television, or with a service such as a package-delivery service.

Help desk 120 organizes customer issues using a ticketing system 122, which generates tickets to represent each customer issue. Ticketing systems are typically associated with a physical or virtual “help desk” for resolving customer problems. Note that although the present invention is described with reference to a ticketing system, it is not meant to be limited to customer-service interactions involving ticketing systems. In general, the invention can be applied to any type of system that enables a customer to resolve a problem with a product or service provided by an organization.

Ticketing system 122 comprises a set of software resources that enable a customer to resolve an issue. In the illustrated embodiment, specific customer issues are associated with abstractions called “tickets,” which encapsulate various data and metadata associated with the customer requests to resolve an issue. (Within this specification, tickets are more generally referred to as “customer requests.”) An exemplary ticket can include a ticket identifier, and information (or links to information) associated with the problem. For example, this information can include: (1) information about the problem; (2) customer information for one or more customers who are affected by the problem; (3) agent information for one or more customer-service agents who are interacting with the customer; (4) email and other electronic communications about the problem (which, for example, can include a question posed by a customer about the problem); (5) information about telephone calls associated with the problem; (6) timeline information associated with customer-service interactions to resolve the problem, including response times and resolution times, such as a first reply time, a time to full resolution and a requester wait time; and (7) effort metrics, such as a number of communications or responses by a customer, a number of times a ticket has been reopened, and a number of times the ticket has been reassigned to a different customer-service agent.

### Article-Suggestion System

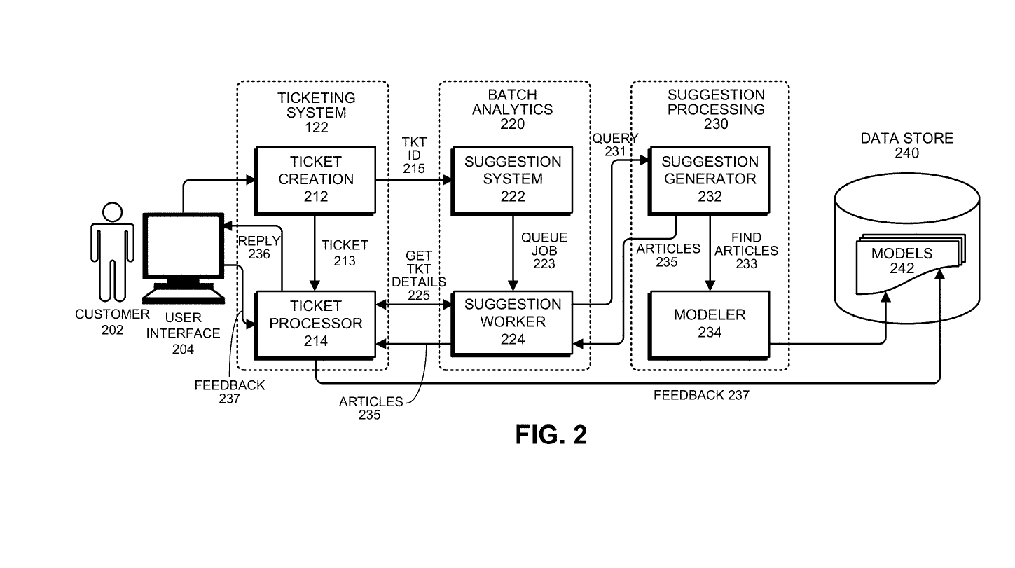

FIG. 2 illustrates various system components involved in the article-suggestion process in accordance with the disclosed embodiments. The process starts with a ticket-creation operation 212 that takes place within ticketing system 122. This ticket-creation operation is triggered by actions of a customer 202 who has an issue with a product or a service, and submits a ticket to obtain help with the issue. Note that customer 202 can submit tickets through a number of possible channels, including through email, online forms, social networking sites, etc. The ticket-creation operation 212 produces a ticket 213 that feeds into a ticket processor 214.

After ticket 213 is created, a ticket identifier (TKT ID) 215 is sent to a suggestion system 222, which is part of a batch analytics system 220 that processes computational tasks in batch mode. (Note that batch analytics system 220 operates asynchronously and can make use of different processes executing on different machines, so as not to block the normal operation of application 124.) Suggestion system 222 causes a job 223 to be queued up for a suggestion worker 224 that performs operations to cause the system to suggest helpful articles that consumer 202 can read to hopefully resolve the issue.

Although the suggestion system operates asynchronously, it nevertheless might introduce a delay between the instant the ticket is created and the moment the suggestions are displayed—more precisely, between the moment the ticket is created and when the suggestions start being computed. Note that the duration of the generation process that causes this delay remains invariant and cannot be avoided at that stage.

While processing job 223, suggestion worker 224 queries ticket processor 214 using ticket ID 215 to obtain ticket details 225. After obtaining ticket details 225, suggestion worker 224 sends a query 231 to suggestion generator 232, which is part of a set of suggestion-processing modules 230, to obtain a set of suggested articles. In response to query 231, suggestion generator 232 sends a request 233 to find articles to a modeler module 234, which uses machine-learning techniques to find a set of helpful articles 235 that are then returned to suggestion worker 224. (This process is described in more detail below.) Next, suggestion worker 224 returns the articles 235 to ticket processor 214, which sends a reply 236 containing the suggested articles 235 to a user interface 204 to be displayed to customer 202. Note that user interface 204 can be implemented in a number of different ways for both mobile and desktop platforms. For example, user interface 204 can be incorporated into: a web page, an email, or a UI screen provided by an application. Next, customer 202 can provide feedback 237 about the suggested articles, and this feedback 237 can be propagated through ticket processor 214 to models that are used to suggest articles 242 contained in data store 240, wherein the feedback can be used to update models 242 to make better predictions about which articles are most helpful for resolving a specific issue.

### Article-Suggestion Process

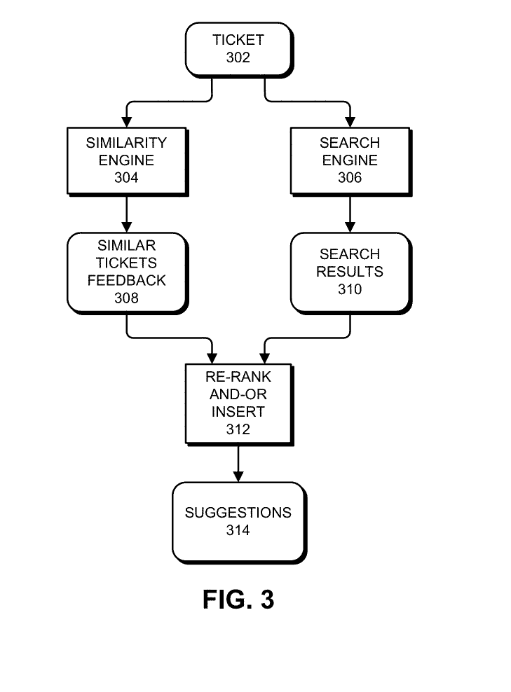

FIG. 3 presents a flow diagram illustrating the article-suggestion process in accordance with the disclosed embodiments. The process starts when the system receives a ticket 302 (or some other type of customer request). Ticket 302 feeds into a similarity engine 304, which looks for similarities between ticket 302 and previously received tickets. The system then obtains feedback 308 listing articles that were helpful in resolving the previously received similar tickets. (Note that when the system first starts processing tickets there are no previously received similar tickets, so the system can skip this left-hand branch of the process until a sufficient number of previous tickets are received to provide meaningful recommendations about helpful articles.)

Ticket 302 also feeds into a conventional search engine 306, which selects a preliminary set of suggested articles from a set of possible articles based on correlations between words in the ticket and words in the set of possible articles. In response, search engine 306 produces a set of search results 310 containing the preliminary set of suggested articles.

Next, the feedback 308 about articles that were helpful in resolving similar tickets is used to re-rank or insert 312 articles into the preliminary set of suggested articles 310 to generate a set of suggestions 314 for articles to be presented to the customer associated with the ticket.

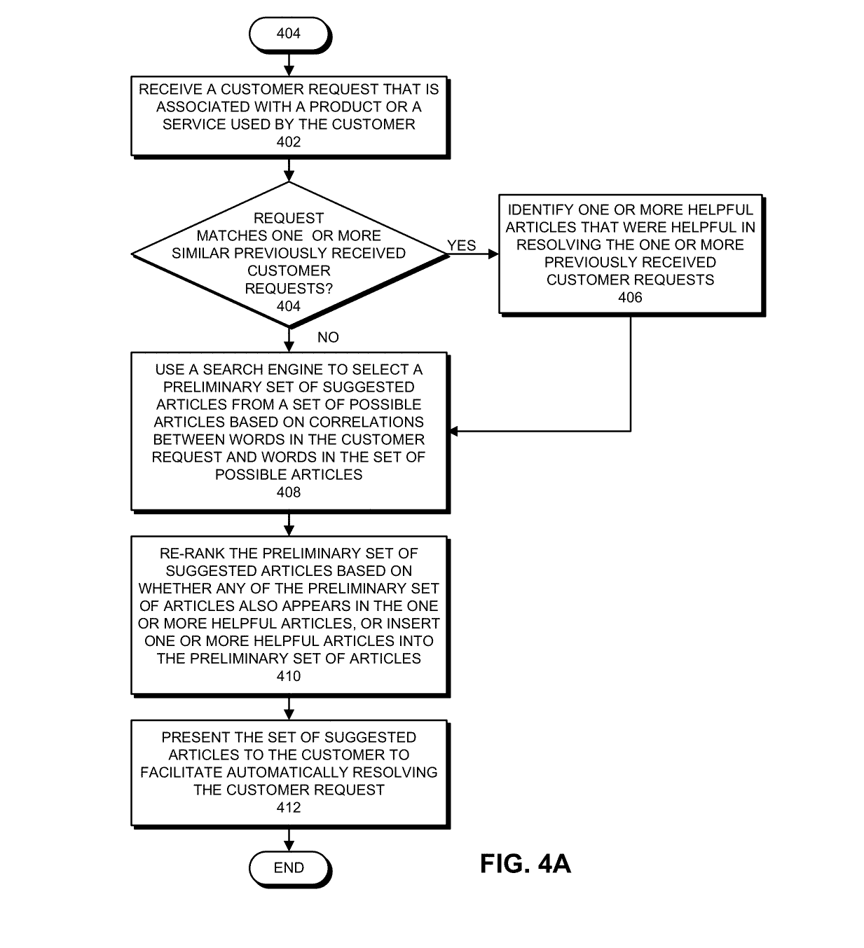

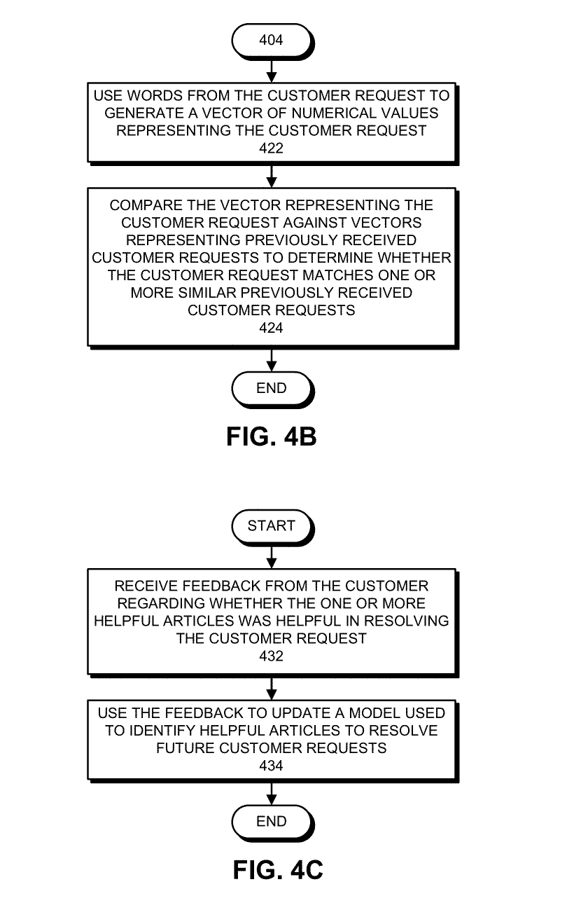

FIG. 4A presents a flow chart illustrating further details about the article-suggestion process in accordance with the disclosed embodiments. First, the system receives a customer request, wherein the customer request is associated with a product or a service used by the customer (step 402). Next, the system determines whether the customer request matches one or more similar previously received customer requests (step 404). If not, the system proceeds directly to step 408. If so, the system identifies one or more helpful articles that were useful in resolving the one or more previously received customer requests (step 406). Next, the customer uses a search engine to select a preliminary set of suggested articles from a set of possible articles based on correlations between words in the customer request and words in the set of possible articles (step 408).

The system then modifies the preliminary set of suggested articles based on the one or more helpful articles to produce the set of suggested articles (step 410). As mentioned above, these modifications can involve: (1) re-ranking a preliminary set of suggested articles based on the one or more helpful articles; or inserting one of the one or more helpful articles into the preliminary set of suggested articles. For example, the system can use the re-ranking technique described in the following article by Wang, et al., which is hereinafter referred to as “Wang” (Chang Wang, Emine Yilmaz, and Martin Szummer. Relevance Feedback Exploiting Query-Specific Document Manifolds. Proceedings of the 20th ACM International Conference on Information and Knowledge Management, CIKM '11, pages 1957-1960, New York, N.Y., USA, 2011. ACM.)

The re-ranking technique described in Wang modifies the ranking of a given ordered set of documents by using explicit feedback information on similar documents. More formally, given a query Q (its type or representation has no importance in this context) and a set F of documents associated with their respective feedback for this query Q, the Wang technique re-ranks a set of documents D (results) where D ∩ F=Ø. Note that the Wang technique could have been the solution to our problem if this approach were not relying on the fact that the two sets of documents are related to the same query.

In our system, we assume that the answer suggestion operation performs an initial search query and re-ranks the results using the method described in Wang, wherein Q is a query formulated from the incoming ticket T₁ (possibly by extracting the most significant terms from its content). However, note that the results D given by the search engine would not necessarily hold the assumption D ∩ F=Ø, which is one of the hypotheses in Wang. Hence, our system modifies the technique Wang by first testing to see if D ∩ F=Ø. If not, our system uses the Wang technique to perform the re-ranking operation. Otherwise, if D ∩ F=Ø, our system skips the re-ranking operation for the set of documents D.

Finally, after the re-ranking process is complete, the system presents the set of suggested articles to the customer to facilitate automatically resolving the customer request (step 412).

FIG. 4B presents a flow chart illustrating how customer requests are compared in accordance with the disclosed embodiments. This flow chart illustrates in more detail the operation performed in step 404 of the flow chart that appears in FIG. 4A in accordance with the disclosed embodiments. First, the system uses words from the customer request (ticket) to generate a vector of numerical values representing the customer request (step 422). During this process, the system first obtains words from the customer request. For example, in cases where the customer request is a ticket, the system can: (1) strip the attributes of the ticket in order to only keep the subject; (2) convert characters into lowercase Unicode format; (3) remove stop words; and (4) delete duplicate words. Next, the system feeds the obtained words into the Doc2Vec model to generate a fixed-length numerical vector to represent the ticket. (See Quoc V. Le and Tomas Mikolov. Distributed Representations of Sentences and Documents. CoRR, abs/1405.4053, 2014.)

Vectors representing tickets are then stored in a large dense matrix as columns. This step produces a matrix T of size n×M, where n is the number of features generated by the Doc2Vec model, and M is the number of points in the data set. Note that the Doc2Vec can be initially trained on different data sets, such as the following: (1) the Brown corpus, which is a compilation of 500 samples of English language text ranging from press articles to popular lore; (2) the NLTK Web and Chat corpus, which is a collection of random online English-speaking conversations (the goal is to train the model with a less formal approach to language); and (3) the content of domain-specific Help Center articles (the goal is to give the model a sense of the important domain-specific language).

Next, the system compares the vector representing the customer request against vectors representing previously received customer requests to determine whether the customer request matches one or more similar previously received customer requests (step 424). During these comparison operations, the system uses the cosine distance as a similarity measure in the feature space generated by the paragraph vector model. The cosine distance is defined as:

$$d ( x , y ) = 1 - \frac{x \cdot y}{‖ x ‖ ‖ y ‖}$$

Finding similar tickets then simply boils down to generating the ticket representation vector t, computing {d(t, v)|v ∈ T} and only retaining vectors with the smallest distance.

In order to rapidly process a large number of similarity values, the system can make use of vectorization to improve performance. For example, vectorizing the computation can involve: (1) computing all the dot products; (2) computing the norms of all vectors; and (3) performing the division operation in-place. Note that during the vectorized computation, these operations can be performed once on a large matrix, instead of multiple times on smaller matrices.

Even though vectorization helps with performance, the technique still has issues in scaling properly because every vector needs to be stored for every ticket that receives feedback, which consumes a large amount of space. Furthermore, the number of cosine similarity values that need to be computed is linear with the number of tickets, which can be a problem if there are a large number of tickets. In order to alleviate these performance issues, the system can use an unsupervised technique, such as DBSCAN. (See Jörg Sander, Martin Ester, Hans-Peter Kriegel, and Xiaowei Xu. Density-Based Clustering in Spatial Databases: The Algorithm GDBSCAN and its Applications. Data Min. Knowl. Discov., 2(2):169-194, June 1998.) By clustering the training set using the DBSCAN technique, the only vectors that need to be retained and computed are the core vectors of every cluster. This ensures that both the space and time complexities remain under control and will not become a problem over time.

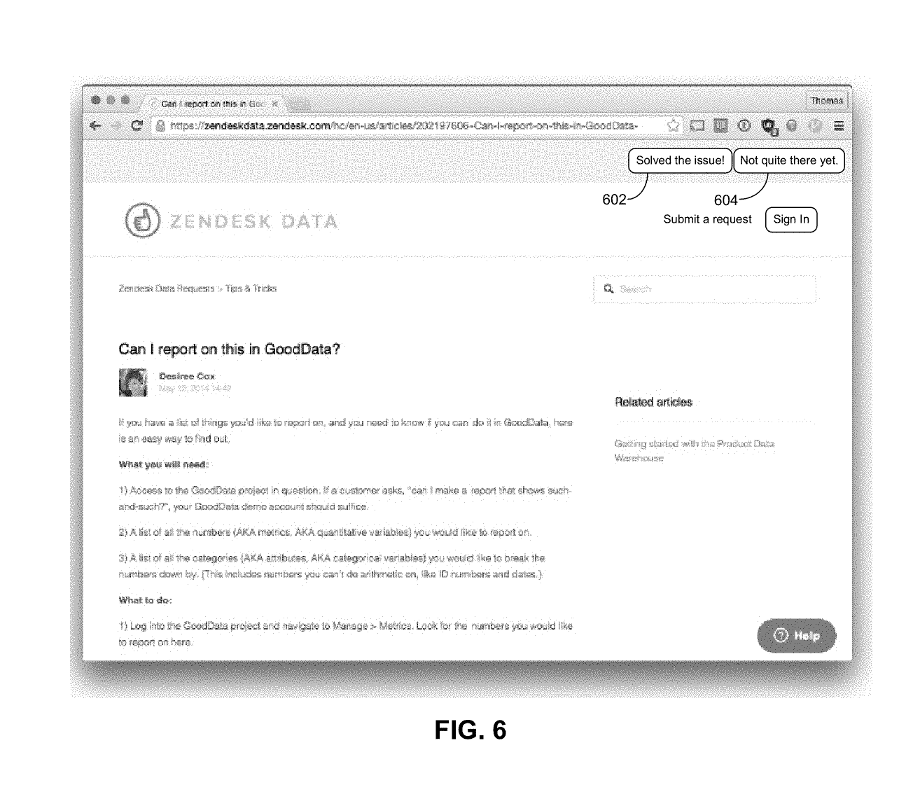

FIG. 4C presents a flow chart illustrating how customer feedback is used to update a model used to identify helpful articles in accordance with the disclosed embodiments. After the suggested articles are presented to the customer in step 412 of the flow chart in FIG. 4A, the system receives feedback from the customer regarding whether the one or more helpful articles were useful in resolving the customer request (step 432). For example, when the customer clicks on a suggested Help Center article through a UI, the UI can present the user with a page that contains the article as is illustrated in FIG. 6. Note that the page illustrated in FIG. 6 provides two buttons 602 and 604 that enable the user to provide feedback by voting on the helpfulness of the suggestion. The system then uses this feedback to update a model used to identify helpful articles to resolve future customer requests (step 434).

When the customers click on a suggested Help Center article link, the system can allow the customer to provide some feedback on the relevance of the suggestion. One option is to gather binary feedback, such as “helpful” and “unhelpful.” Because most online services have a similar feedback system, this type of feedback is familiar to most customers and will be unlikely to confuse the customer. For example, once the customer clicks on one of the article links, the customer's browser can navigate to the associated article, which is displayed along with a bar at the top of the page. This bar can give the user some contextual information about the feedback, and can provide two buttons (e.g., “helpful” or “unhelpful”) to vote on the helpfulness of the suggestion. This feedback can be stored in some type of database, such as a MySQL table. The system can also gather other types of feedback, such as a rating of an article's helpfulness on a numerical scale, (e.g., from one to five stars). The system can additionally gather implicit feedback, such as click-through rate or time spent on the article, as well as customers' information, such as language preference, or navigation history to avoid suggesting articles the customer has already read.

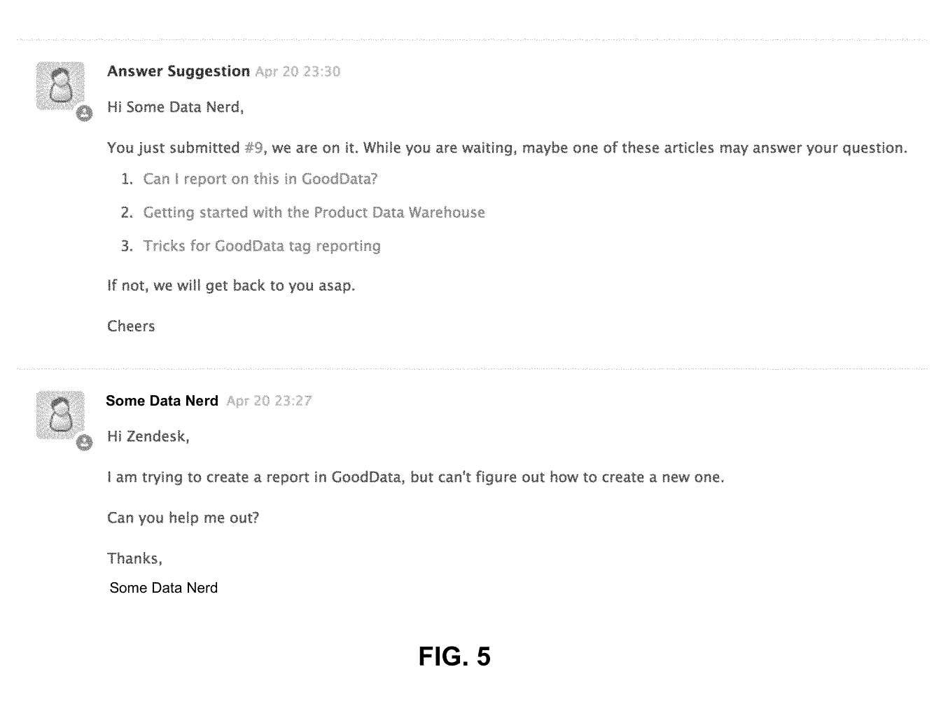

FIG. 5 illustrates how suggested articles can be presented to a customer in accordance with the disclosed embodiments. On the bottom half of the screen, a customer called “Some Data Nerd” enters a request that asks a question about creating a new report. For example, this question can be entered into an email or input on a screen for an application. Next, on the top half of the screen, the system suggests three articles that the customer can read to resolve the request; the customer can click on the names of the suggested articles to read them.

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A method for suggesting helpful articles to automatically resolve a customer request, comprising:
receiving the customer request, wherein the customer request is associated with a product or a service used by the customer;
using a search engine to select a preliminary set of suggested articles from a set of possible articles based on correlations between words in the customer request and words in the set of possible articles;
determining whether the customer request matches one or more similar previously received customer requests;
if the customer request matches one or more previously received customer requests,
identifying one or more helpful articles that were useful in resolving the one or more previously received customer requests, and
modifying the preliminary set of suggested articles based on the one or more helpful articles to produce the set of suggested articles;
if the customer request does not match any of the previously received customer requests, using the preliminary set of suggested articles as the set of suggested articles; and
presenting the set of suggested articles to the customer to facilitate automatically resolving the customer request.

2. The method of claim 1, wherein modifying the preliminary set of suggested articles based on the one or more helpful articles includes re-ranking the preliminary set of suggested articles based on whether any of the preliminary set of articles also appears in the one or more helpful articles.

3. The method of claim 1, wherein modifying the preliminary set of suggested articles based on the one or more helpful articles includes inserting at least one of the one or more helpful articles into the preliminary set of suggested articles.

4. The method of claim 1, wherein the method further comprises:
receiving feedback from the customer regarding whether the one or more suggested articles were helpful in resolving the customer request; and
using the feedback to update a model used to identify helpful articles to resolve future customer requests.

5. The method of claim 4, wherein receiving the feedback from the customer includes receiving the feedback through a user interface that displays a suggested article along with user interface elements that enable the customer to provide feedback.

6. The method of claim 1, wherein determining whether the customer request matches one or more similar previously received customer requests includes:
using words from the customer request to generate a vector of numerical values representing the customer request; and
comparing the vector representing the customer request against vectors representing previously received customer requests to determine whether the customer request matches one or more similar previously received customer requests.

7. The method of claim 6, wherein generating the vector includes using the Doc2Vec technique to generate the vector to represent the customer request.

8. The method of claim 1, wherein the customer request includes a question from the customer about the product or the service used by the customer.

9. The method of claim 1, wherein the customer request comprises a ticket associated with a customer issue in a help desk ticketing system.

10. The method of claim 9, wherein the method is performed asynchronously by the help desk system after the ticket is initially processed by the help desk ticketing system.

11. A non-transitory computer-readable storage medium storing instructions that when executed by a computer cause the computer to perform a method for suggesting helpful articles to automatically resolve a customer request, the method comprising:
receiving the customer request, wherein the customer request is associated with a product or a service used by the customer;
using a search engine to select a preliminary set of suggested articles from a set of possible articles based on correlations between words in the customer request and words in the set of possible articles;
determining whether the customer request matches one or more similar previously received customer requests;
if the customer request matches one or more previously received customer requests,
identifying one or more helpful articles that were useful in resolving the one or more previously received customer requests; and
modifying the preliminary set of suggested articles based on the one or more helpful articles to produce the set of suggested articles;
if the customer request does not match any of the previously received customer requests, using the preliminary set of suggested articles as the set of suggested articles; and
presenting the set of suggested articles to the customer to facilitate automatically resolving the customer request.

12. The non-transitory computer-readable storage medium of claim 11, wherein modifying the preliminary set of suggested articles based on the one or more helpful articles includes re-ranking the preliminary set of suggested articles based on whether any of the preliminary set of articles also appears in the one or more helpful articles.

13. The non-transitory computer-readable storage medium of claim 11, wherein modifying the preliminary set of suggested articles based on the one or more helpful articles includes inserting at least one of the one or more helpful articles into the preliminary set of suggested articles.

14. The non-transitory computer-readable storage medium of claim 11, wherein the method further comprises:
receiving feedback from the customer regarding whether the one or more suggested articles were helpful in resolving the customer request; and
using the feedback to update a model used to identify helpful articles to resolve future customer requests.

15. The non-transitory computer-readable storage medium of claim 14, wherein receiving the feedback from the customer includes receiving the feedback through a user interface that displays a suggested article along with user interface elements that enable the customer to provide feedback.

16. The non-transitory computer-readable storage medium of claim 11, wherein determining whether the customer request matches one or more similar previously received customer requests includes:
using words from the customer request to generate a vector of numerical values representing the customer request; and
comparing the vector representing the customer request against vectors representing previously received customer requests to determine whether the customer request matches one or more similar previously received customer requests.

17. The non-transitory computer-readable storage medium of claim 16, wherein generating the vector includes using the Doc2Vec technique to generate the vector to represent the customer request.

18. The non-transitory computer-readable storage medium of claim 11, wherein the customer request includes a question from the customer about the product or the service used by the customer.

19. The non-transitory computer-readable storage medium of claim 11, wherein the customer request comprises a ticket associated with a customer issue in a help desk ticketing system.

20. The non-transitory computer-readable storage medium of claim 19, wherein the method is performed asynchronously by the help desk system after the ticket is initially processed by the help desk ticketing system.

21. A system that suggests helpful articles to automatically resolve a customer request, comprising:
at least one processor and at least one associated memory; and
a request-processing mechanism that executes on the at least one processor, wherein during operation, the request-processing mechanism:
receives the customer request, wherein the customer request is associated with a product or a service used by the customer;
uses a search engine to select a preliminary set of suggested articles from a set of possible articles based on correlations between words in the customer request and words in the set of possible articles;
determines whether the customer request matches one or more similar previously received customer requests;
if the customer request matches one or more previously received customer requests,
identifies one or more helpful articles that were useful in resolving the one or more previously received customer requests, and
modifies the preliminary set of suggested articles based on the one or more helpful articles to produce the set of suggested articles;
if the customer request does not match any of the previously received customer requests, uses the preliminary set of suggested articles as the set of suggested articles; and
presents the set of suggested articles to the customer to facilitate automatically resolving the customer request.

22. The system of claim 21, wherein while modifying the preliminary set of suggested articles based on the one or more helpful articles, the request-processing mechanism re-ranks the preliminary set of suggested articles based on whether any of the preliminary set of articles also appears in the one or more helpful articles.

23. The system of claim 21, wherein while modifying the preliminary set of suggested articles based on the one or more helpful articles, the request-processing mechanism inserts at least one of the one or more helpful articles into the preliminary set of suggested articles.

24. The system of claim 21, wherein the request-processing mechanism additionally:
receives feedback from the customer regarding whether the one or more suggested articles were helpful in resolving the customer request; and
uses the feedback to update a model used to identify helpful articles to resolve future customer requests.

25. The system of claim 24, wherein while receiving the feedback from the customer the request-processing mechanism receives the feedback through a user interface that displays a suggested article along with user interface elements that enable the customer to provide feedback.

26. The system of claim 21, wherein while determining whether the customer request matches one or more similar previously received customer requests, the request-processing mechanism:
uses words from the customer request to generate a vector of numerical values representing the customer request; and
compares the vector representing the customer request against vectors representing previously received customer requests to determine whether the customer request matches one or more similar previously received customer requests.

27. The system of claim 26, wherein while generating the vector, the request-processing mechanism uses the Doc2Vec technique to generate the vector to represent the customer request.

28. The system of claim 21, wherein the customer request includes a question from the customer about the product or the service used by the customer.

29. The system of claim 21, wherein the customer request comprises a ticket associated with a customer issue in a help desk ticketing system.

30. The system of claim 29, wherein the request-processing system operates asynchronously after the ticket is initially processed by the help desk ticketing system.
